(19) United States
(12) Patent Application Publication
(10) Pub. No.: US 2026/0057035 A1
(43) Pub. Date: Feb. 26, 2026

(54) LOW-LATENCY CONVOLUTION OPERATION APPARATUS AND METHOD FOR MOBILE ENVIRONMENTS

(71) Applicant: SEOUL NATIONAL UNIVERSITY R&DB FOUNDATION, Seoul (KR)

(72) Inventors: Kyunghan LEE, Seoul (KR); Kyungmin BIN, Seoul (KR); Jong Seok PARK, Seoul (KR)

(21) Appl. No.: 19/377,100

(22) Filed: Nov. 3, 2025

Related U.S. Application Data
(63) Continuation of application No. PCT/KR2023/015677, filed on Oct. 12, 2023.

(30) Foreign Application Priority Data
May 15, 2023 (KR) 10-2023-0062180

(51) Int. Cl. G06F 17/15; G06F 17/16

(52) U.S. Cl. CPC G06F 17/153; G06F 17/16

(57) ABSTRACT

A low-latency convolution operation apparatus according to an embodiment includes: a memory in which a matrix operation program is stored; and a processor configured to execute the program stored in the memory, wherein the matrix operation program includes a matrix operation unit configured to generate an output matrix by performing element-wise matrix operations between an input matrix and a filter matrix, the matrix operation unit being configured to: (a) match rows of the input matrix with columns of the filter matrix in consideration of convolution parameters including stride and dilation; (b) compute filter blocks that move in a depthwise direction and input blocks that move in a horizontal direction along the width dimension of a filter tensor to generate output blocks; and (c) repeat steps (a) and (b) and aggregate all computed output blocks into a single matrix to generate the output matrix.

### CROSS-REFERENCE TO RELATED APPLICATION

This application is a continuation of International Application No. PCT/KR2023/015677 filed on Oct. 12, 2023, which claims the benefit under 35 USC 119(a) of Korean Patent Application No. 10-2023-0062180 filed on May 15, 2023 in the Korean Intellectual Property Office, the entire disclosures of which are incorporated herein by reference for all purposes.

### BACKGROUND

### Field

The present invention relates to a low-latency convolution operation apparatus and method for mobile environments.

### SUMMARY

Currently, many artificial neural network-based services, such as object recognition and image processing, use convolution operations as a core component. Most conventional neural network implementations convert convolution operations into matrix multiplication (GEMM, General Matrix Multiplication) operations for processing, and the same approach is applied in mobile environments.

However, the conversion of convolution operations into GEMM operations causes data duplication and movement overhead, reducing data reuse rate and degrading computational performance. In conventional server or desktop environments, neural networks are often trained using large amounts of data, or various service requests are processed simultaneously. In such environments, a strategy is used to batch large volumes of data and process them through a single neural network operation. This reduces the proportion of time consumed by data duplication and movement, while increasing data reuse rate by repeating the same operation on a large dataset.

In contrast, mobile environments typically provide neural network services based on individual user requests, operating on single data instances. Thus, the strategy of processing batched data is not feasible. As a result, the performance degradation caused by data duplication and low data reuse rate in the conventional GEMM approach becomes more pronounced.

Furthermore, neural network services provided in mobile environments must deliver results for individual user requests with minimal delay in order to maximize user satisfaction. To this end, it is essential to minimize the total time from request to result delivery, even when only a small amount of data is involved.

Therefore, although the conventional GEMM approach improves average processing speed per data unit by batch processing large datasets, it also increases the latency until each individual result is produced. Consequently, the conventional GEMM approach is not suitable for mobile environments where rapid response to user requests is required.

In this regard, FIG. 1 illustrates the iteration of the N dimension in a typical GEMM operation. The N iteration reuses the data of matrix A. FIG. 2 illustrates the iteration of the output width (Wout) dimension in a typical 2D CNN operation. The Wout iteration reuses the data of the filter tensor.

For example, as shown in FIG. 1, a matrix multiplication (GEMM) operation iterates through three computation dimensions, M, N, and K, in the form of a nested loop for three matrices A, B, and C. In this case, loop iterations along the computation dimensions M, N, and K reuse the data corresponding to matrices B, A, and C, respectively, in the next operations. In contrast, a 2D CNN operation performs nested loops across seven dimensions for the 4D tensors: input, filter, and output. These computation dimensions include batch, input channels (Cin), output channels (Cout), output height (Hout), output width (Wout), filter height (Hfil), and filter width (Wfil).

The conventional approach of converting a CNN into GEMM typically maps the input, filter, and output tensors to matrices B, A, and C, respectively, and maps the seven CNN computation dimensions to the three GEMM computation dimensions. In this mapping, the CNN computation dimensions other than the spatial dimensions of the filter (Hfil, Wfil) can be directly mapped to GEMM computation computational dimensions. However, the spatial dimensions of the filter exhibit different data access and reuse patterns compared to the GEMM computation dimensions M, N, and K, making direct mapping infeasible. To address this, additional processing such as Im2col is required, resulting in increased computation time due to data duplication and rearrangement overhead.

Accordingly, since the spatial dimensions of the filter cannot be expressed in terms of GEMM computation dimensions, the conventional approach of converting CNNs into GEMM is inefficient.

The present invention is devised to solve the aforementioned problems, and aims to provide a low-latency convolution operation apparatus and method for mobile environments, capable of providing faster processing performance on small amounts of data compared to the conventional GEMM approach.

However, the technical problems to be solved by the present embodiment are not limited to those described above, and other technical challenges may exist.

As a technical means for solving the above problem, a low-latency convolution operation apparatus according to an embodiment of the present invention comprises: a memory in which a matrix operation program is stored; and a processor configured to execute the program stored in the memory. The matrix operation program includes a matrix operation unit configured to generate an output matrix based on element-wise matrix operations between an input matrix and a filter matrix. The matrix operation unit includes: (a) matching rows of the input matrix with columns of the filter matrix in consideration of convolution parameters including stride and dilation; (b) generating output blocks by computing a filter block, which moves in the depthwise direction with respect to the width dimension of the filter tensor, and an input block, which moves in the horizontal direction; and (c) generating the output matrix by aggregating all output blocks computed by repeating steps (a) and (b) into a single matrix. The input matrix includes input blocks in which the width and channel dimensions are arranged in the horizontal and vertical directions, respectively. The filter matrix includes filter blocks in which the channel dimensions are arranged in both the horizontal and vertical directions, and the width dimension is arranged in the depthwise direction.

According to another embodiment of the present invention, the low-latency convolution operation method executed by the low-latency convolution operation apparatus includes a step in which the matrix operation unit generates an output matrix by performing element-wise matrix operations between the input matrix and the filter matrix. The generating step includes: (a) matching rows of the input matrix with columns of the filter matrix in consideration of convolution parameters including stride and dilation; (b) generating output blocks by computing a filter block moving in the depthwise direction with respect to the width dimension of the filter tensor and an input block moving in the horizontal direction; and (c) generating the output matrix by aggregating all output blocks computed by repeating steps (a) and (b) into a single matrix. The input matrix includes input blocks where the width and channel dimensions are arranged in the horizontal and vertical directions, respectively, and the filter matrix includes filter blocks where the channel dimensions are arranged in both the horizontal and vertical directions, and the width dimension is arranged in the depthwise direction.

According to at least one of the means for solving the problem described above, memory usage and computation latency in neural network processing can be reduced compared to conventional approaches. This enables more efficient neural network processing in mobile environments that rely on limited memory, hardware resources, and battery power.

Moreover, reduced memory usage provides advantages in processing performance. It also alleviates memory access bottlenecks in mobile systems where various computing resources such as CPU, GPU, and DSP share the same main memory and bus. As a result, users can experience smoother neural network services.

Additionally, by eliminating overhead and improving computational efficiency, latency is further reduced. This reduces the amount of energy required to operate the neural network and allows mobile systems with limited battery capacity to more easily utilize neural network-based services.

### BRIEF DESCRIPTION OF THE DRAWINGS

FIG. 1 is a diagram illustrating the iteration of the N-dimension in a typical GEMM operation.

FIG. 2 is a diagram illustrating the iteration of the output width (Wout) dimension in a typical 2D CNN operation.

FIG. 3 is a diagram illustrating the structure of a low-latency convolution operation apparatus for a mobile environment according to an embodiment of the present invention.

FIG. 4 is a diagram illustrating the structure of a matrix operation unit according to an embodiment of the present invention.

FIG. 5 is a flowchart illustrating an operation method of the matrix operation unit shown in FIG. 4.

FIGS. 6A, 6B, 6C, 6D, and 6E are diagrams illustrating an operation method of a structure combining Im2Col and GEMM in a conventional method of converting a CNN into a GEMM.

FIGS. 7A, 7B, 7C, 7D, and 7E are diagrams for illustrating the operation method of the matrix operation unit shown in FIG. 4.

FIG. 8 is a diagram illustrating an algorithm of a low-latency convolutional neural network operation method according to an embodiment of the present invention.

FIG. 9 is a diagram illustrating a comparison between the low-latency convolution operation method according to an embodiment of the present invention and a conventional method.

### DETAILED DESCRIPTION

Hereinafter, embodiments of the present invention will be described in detail with reference to the accompanying drawings so that those skilled in the art may easily carry out the invention. However, the present invention may be implemented in various forms and is not limited to the embodiments described herein. In order to clearly explain the invention in the drawings, parts not related to the description are omitted, and like reference numerals are assigned to like elements throughout the specification.

Throughout this specification, when a part is said to be “connected” to another part, it includes not only cases where they are “directly connected” but also cases where they are “electrically connected” with another component interposed therebetween. Also, when a part is said to “include” a certain component, it does not exclude other components unless specifically stated otherwise, and it may further include other components.

In this specification, the term “unit” refers to a component realized by hardware, a component realized by software, or a component realized using both. A single unit may be implemented using two or more hardware elements, or two or more units may be implemented by a single hardware element. The term “˜unit” is not limited to software or hardware and may be implemented to exist in an addressable storage medium or be configured to cause one or more processors to execute specific functions. For example, the “˜unit” may include software components, object-oriented software components, class components, task components, and elements such as processes, functions, properties, procedures, subroutines, program code segments, drivers, firmware, microcode, circuits, data, databases, data structures, tables, arrays, and variables. The functions provided within components or “˜units” may be integrated into a smaller number of components or “˜units,” or further divided into additional components or “˜units.” Moreover, the components or “˜units” may be implemented to operate one or more CPUs within a device.

A network refers to a connection structure in which nodes such as terminals and servers can exchange information with one another, and may include a Local Area Network (LAN), a Wide Area Network (WAN), the Internet (WWW), wired/wireless data communication networks, telephone networks, and wired/wireless television communication networks. Examples of wireless data communication networks include, but are not limited to, 3G, 4G, 5G, 3GPP (3rd Generation Partnership Project), LTE (Long Term Evolution), WiMAX (Worldwide Interoperability for Microwave Access), Wi-Fi, Bluetooth communication, infrared communication, ultrasonic communication, Visible Light Communication (VLC), and LiFi.

Hereinafter, an embodiment of the present invention will be described in detail with reference to the accompanying drawings.

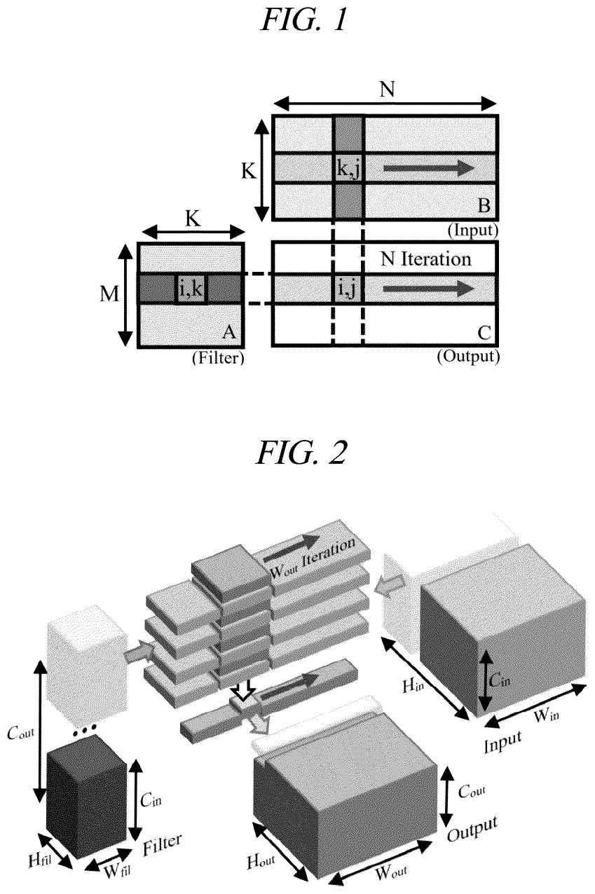

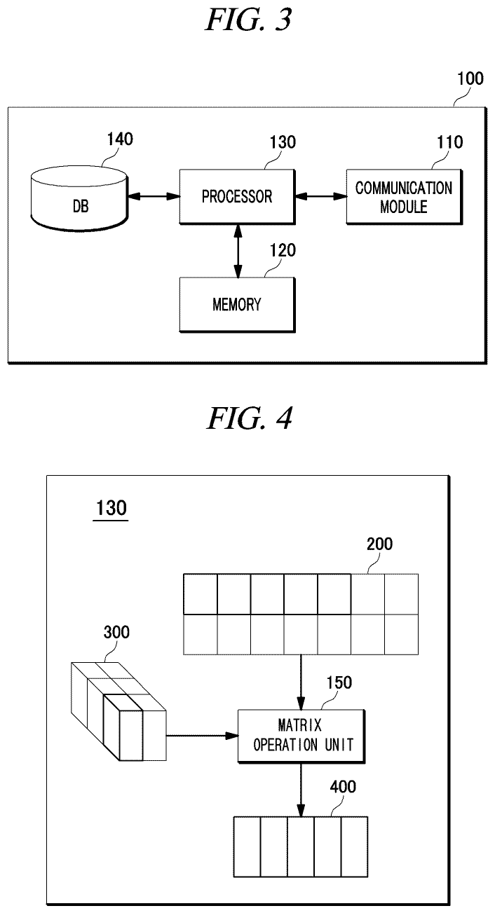

First, in conventional mobile environments, matrix multiplication (GEMM) operations are mainly used to perform convolution operations. However, as described above with reference to FIGS. 1 and 2, GEMM operations have inefficiencies such as slow processing speeds due to overhead from data duplication and rearrangement, and a lower data reuse rate compared to convolution operations. These inefficiencies cause even greater performance degradation in artificial neural networks operating in mobile environments.

To address the above issues, the present invention relates to a low-latency convolution operation apparatus and method designed to accelerate convolutional neural network processing, which is a key component in artificial neural network computation, while taking into account the characteristics of mobile environments.

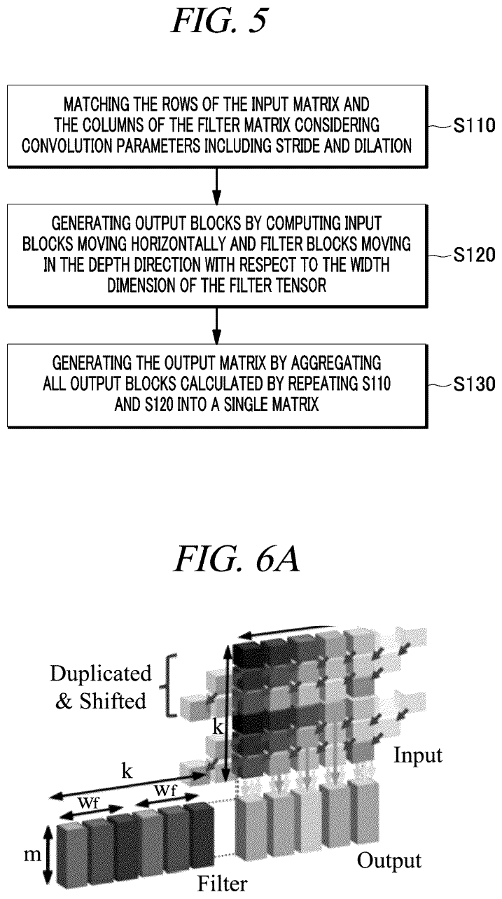

FIG. 3 is a diagram illustrating the structure of a low-latency convolution operation apparatus for a mobile environment according to an embodiment of the present invention.

Referring to FIG. 3, the convolution operation apparatus (100) may include a communication module (110), a memory (120), a processor (130), and a database (140).

The communication module (110) may receive input data and transmit it to the processor (130). The communication module (110) may include hardware and software necessary for transmitting and receiving signals such as control signals or data signals through wired or wireless connections with other network devices.

The memory (120) may store a matrix operation program. The matrix operation program includes a matrix operation unit that generates an output matrix based on element-wise matrix operations between an input matrix and a filter matrix. The matrix operation unit performs: (a) a step (S110) of matching rows of the input matrix with columns of the filter matrix in consideration of convolution parameters including stride and dilation; (b) a step (S120) of generating an output block by computing a filter block, which moves in the depthwise direction over the width dimension of the filter tensor, and an input block, which moves in the horizontal direction; and (c) a step (S130) of generating an output matrix by aggregating all output blocks obtained by repeating steps (S110) and (S120) into a single matrix.

The memory (120) may include, in addition to volatile storage devices requiring power to retain stored information, magnetic storage media or flash storage media. However, the scope of the present invention is not limited thereto.

The memory (120) may also store separate programs such as an operating system for processing and controlling by the processor (130), and may perform a temporary storage function for input or output data.

The processor (130) executes the matrix operation program (hereinafter, the “program”) stored in the memory (120), and provides a function of controlling the hardware of the convolution operation apparatus (100) according to the execution of the program. That is, by executing the program, the processor (130) may perform hardware control functions such as file system management, memory allocation, network management, basic libraries, timers, device control (e.g., display, media, input devices, 3D), and other utilities.

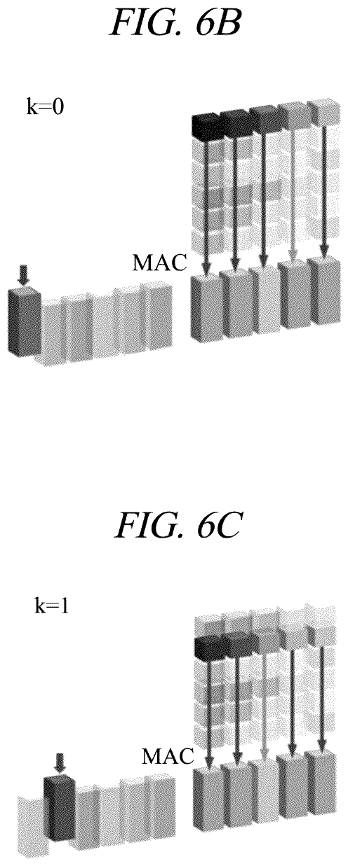

The detailed steps of the matrix computation process performed by the execution of the program will be described later with reference to FIGS. 4 through 7E.

The processor (130) may include any type of device capable of processing data. For example, it may refer to a data processing device embedded in hardware with physically structured circuits for executing functions expressed by codes or instructions contained in the program. Examples of such hardware-based data processing devices may include, but are not limited to, a microprocessor, a central processing unit (CPU), a processor core, a multiprocessor, an application-specific integrated circuit (ASIC), or a field programmable gate array (FPGA).

The database (140), under the control of the processor (130), stores or provides data required by the convolution operation apparatus (100). The database (140) may be included as a component separate from the memory (120), or it may be configured within a specific area of the memory (120).

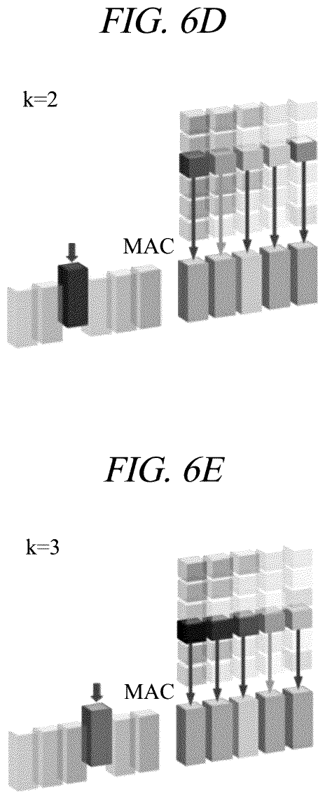

FIG. 4 illustrates the structure of a matrix operation unit according to an embodiment of the present invention, and FIG. 5 is a flowchart illustrating a computation method of the matrix operation unit shown in FIG. 4.

Referring to FIG. 4, the processor (130) includes a matrix operation unit (150) that generates an output matrix (400) based on element-wise matrix operations between an input matrix (200) and a filter matrix (300).

Referring to FIG. 5, the matrix operation unit (150) includes: a step (S110) of matching rows of the input matrix (200) with columns of the filter matrix (300) in consideration of convolution parameters including stride and dilation; a step (S120) of generating an output block by computing a filter block, which moves in the depthwise direction over the width dimension of the filter tensor, and an input block, which moves in the horizontal direction; and a step (S130) of generating an output matrix (400) by aggregating all output blocks obtained through repeated execution of steps (S110) and (S120). Here, the convolution parameters include, but are not limited to, stride and dilation.

Prior to step S110, the matrix operation unit (150) may map the convolution computation dimensions of the target computation to GEMM computation dimensions and may tile the input matrix (200) and the filter matrix (300) into a plurality of blocks of a predetermined size. The tiling process may utilize conventional GEMM computation methods, and detailed descriptions thereof are omitted. Here, a block refers to a partial matrix resulting from dividing each matrix into a predetermined size, and the partial matrix includes adjacent elements.

The input matrix (200) includes blocks in which the width dimension and the channel dimension are arranged in the horizontal and vertical directions, respectively. The filter matrix (300) includes filter blocks in which the channel dimension is arranged in both the horizontal and vertical directions, and the width dimension is arranged in the depthwise direction. The output matrix (400) includes blocks in which the width and channel dimensions are arranged in the horizontal and vertical directions, respectively.

Accordingly, the present invention proposes a new algorithm that eliminates the inefficiencies arising from the conventional GEMM method. Through this, the processing time for artificial neural networks in mobile environments can be significantly reduced.

Specifically, the present invention proposes a new algorithm based on the observation that the inefficiencies in converting conventional CNN computations into GEMM computations stem from the inability of GEMM to represent all CNN computation dimensions. That is, the low-latency convolutional neural network computation apparatus according to an embodiment of the present invention extends the conventional GEMM method by adding a new computation dimension that corresponds to the filter spatial dimension of the CNN computation, which cannot be expressed in the conventional GEMM algorithm.

Here, the added computation dimension represents the spatial dimensions (width and height) of the filter (kernel) in CNN computation. This dimension is characterized by reusing input (feature map) and output data while newly accessing the filter data. Meanwhile, the present invention allows parts of CNN computations that can be handled by the conventional GEMM algorithm to be processed using the existing GEMM operations as-is. However, for parts that cannot be handled by the conventional GEMM algorithm—specifically, the spatial dimension of the filter—the present invention uses the newly added computation dimension. That is, the present invention, through the matrix operation unit (150), enables efficient processing of all CNN computations, including the filter spatial dimensions that could not be handled by the conventional GEMM algorithm. Therefore, convolutional neural network processing in mobile environments can be performed rapidly and efficiently.

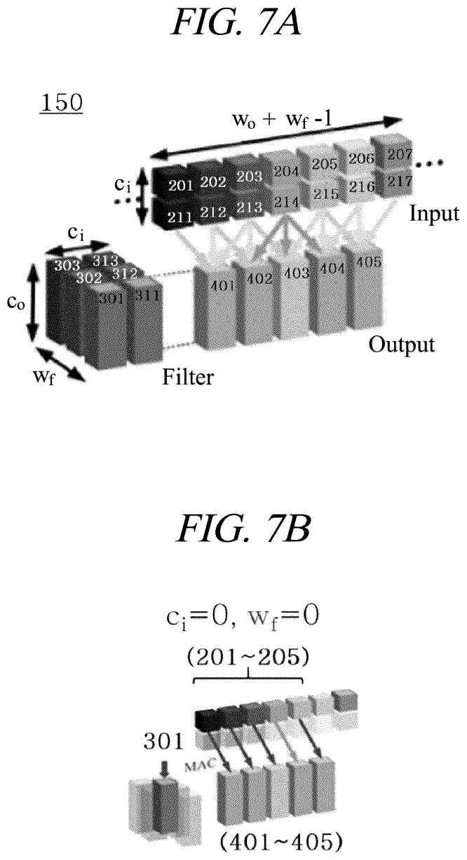

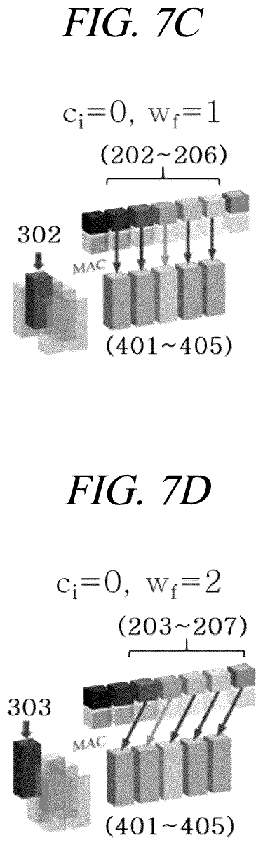

FIGS. 6A to 6E are diagrams illustrating a computation method based on a combined structure of Im2Col and GEMM, which is a conventional approach for converting CNN into GEMM. FIGS. 7A to 7E are diagrams for explaining the computation method of the matrix operation unit shown in FIG. 4.

First, the problems occurring during computation using the conventional combined structure (Im2Col+GEMM) will be described with reference to FIGS. 6A to 6E.

FIGS. 6A to 6E illustrate a process of performing CNN computation using the most commonly used conventional combined structure (Im2Col+GEMM) for converting CNN operations into GEMM.

In the conventional combined structure (Im2Col+GEMM), the filter width dimension (Wf) is flattened into the K matrix dimension using the input channel dimension (Ci). Accordingly, as shown in FIG. 6A, reuse of the input block in the filter width dimension (Wf) is represented by duplication and shifting of the input block. That is, in order to process CNN filter spatial dimension computations—which cannot be directly expressed—within the framework of GEMM operations, the conventional combined structure undergoes additional processes such as duplication and rearrangement of input data (e.g., Im2Col). During this process, opportunities for data reuse originally provided by the filter spatial dimension of the CNN are restricted.

However, the low-latency convolution operation apparatus (100) of the present invention can perform computations without additional processes such as data duplication and rearrangement, by performing iteration over the filter width dimension (Wf) added to the filter matrix (300), unlike the conventional combined structure.

Hereinafter, the computation process by the matrix operation unit (150) of the present invention will be described with reference to FIGS. 7A to 7E. FIGS. 7A to 7E represent mathematically equivalent computation processes to those illustrated in FIGS. 6A to 6E.

Referring to FIGS. 4 and 7A, the matrix operation unit (150) may generate an output matrix (400) by performing element-wise matrix operation between the input matrix (200) and the filter matrix (300).

For example, the matrix operation unit (150) may calculate an output block based on the horizontal position of the input block and the depthwise position of the filter block, according to Equation 1.

$$Wo + Wf - 1 \qquad [ Equation 1 ]$$

Here, Wo denotes the output width dimension, and Wf denotes the filter width dimension.

The matrix operation unit (150) may match the rows of the input matrix (200) with the columns of the filter matrix (300) with respect to the input channel dimension (Ci). For instance, as shown in FIG. 7A, the matrix operation unit (150) may perform computation between the filter blocks (301-303), in which the input channel dimension is located at the first column (Ci=0), and the input blocks (201-207), in which the input channel dimension is located at the first row (Ci=0).

In addition, the matrix operation unit (150) may compute the filter blocks (301-303, 311-313), which move in the depthwise direction with respect to the filter width dimension (Wf), and the input blocks (201-207, 211-217), which move in the horizontal direction, to generate output blocks (401-405). For example, as shown in FIGS. 7B to 7D, the input channel dimension may be set to the first column of the filter matrix and the first row of the input matrix (Ci=0). In this case, as the filter blocks (301, 302, 303) move across the filter width dimension at depths 0 (Wf=0), 1 (Wf=1), and 2 (Wf=2), the input blocks (201-205, 202-206, 203-207) may move one block at a time in the horizontal direction and perform computations. At this time, the number of columns of input blocks involved in a computation with one filter block is five, and this number may determine the number of columns in the resulting output block.

Next, referring to FIG. 7E, the matrix operation unit (150) may also perform computation between the filter blocks (311-313) and the input blocks (211-217), which correspond to the second column of the filter matrix and the second row of the input matrix (Ci=1), by moving one block at a time along the filter width dimension (Wf). That is, element-wise multiplication is performed between the input blocks (201-207, 211-217) and the filter blocks (301-303, 311-313), and the resulting computed values are accumulated to generate the output blocks (401-405).

In this case, in the computation process shown in FIGS. 7A to 7E, the shaded blocks represent data that has been loaded into registers, and the arrows from input to output indicate that a MAC (Multiply-Accumulate) operation is being performed on the loaded data.

As an example, the computation process in which the matrix operation unit (150) performs operations by moving one block at a time along the filter width dimension (Wf), when the input channel dimension is Ci=0, will be described with reference to FIGS. 7B to 7D.

As shown in FIG. 7B, the first filter block (301) positioned at depth 0 (Wf=0) performs computation with the first group of input blocks (201-205), and the resulting values may be stored in the locations of the first to fifth output blocks (401-405).

As shown in FIG. 7C, the second filter block (302) positioned at depth 1 (Wf=1) performs computation with the second group of input blocks (202-206), and the resulting values may be stored in the locations of the first to fifth output blocks (401-405).

As shown in FIG. 7D, the third filter block (303), positioned at depth 2 (Wf=2), performs computation with the third group of input blocks (203-207), and the resulting computed values may be stored in the locations of the first to fifth output blocks (401-405).

In addition, as shown in FIG. 7E, even when the input channel dimension is Ci=1, the matrix operation unit (150) can perform computation by moving one block at a time along the filter width dimension. Likewise, the results of computation between each filter block (311, 312, 313) and the corresponding groups of input blocks (211-215, 212-216, 213-217) may be stored in the locations of the first to fifth output blocks (401-405). The accumulated computation results are finally summed, and the output blocks (401-405) are generated.

Further, the computation results processed per input group (i.e., five columns) can be stored in bulk in the output group (i.e., five columns) including the output blocks (401-405). For example, the output group (401-405) may be positioned in the first row (Wo=0) of the output width dimension.

Illustratively, the direction of the arrows (representing MAC operations) may indicate which output block the result of each group of input blocks corresponding to the filter width dimension (Wf) is stored in.

For example, according to Equation 1, for the first group, Wo(0)+Wf(0)−1=−1; for the second group, Wo(0)+Wf(1)−1=0; and for the third group, Wo(0)+Wf(2)−1=1 may be derived. That is, the direction of the arrow connecting the first group of input blocks (201-205) to the output group (401-405) may point to the right ( [symbol] ). The arrow for the second group (202-206) may remain vertical (↓), and the third group (203-207) may point to the left ( [symbol] ).

In other words, the present invention enables omission of the input block duplication and rearrangement process in the input matrix (200) by utilizing the filter width dimension (Wf) of the filter matrix (300). Additionally, it maximizes the opportunity for data reuse in the spatial dimension of the CNN filter. In this manner, the present invention performs mathematically equivalent operations to those of the conventional combination structure while omitting the data duplication process. That is, the same input data (input blocks) can be reused in more computations. As a result, it uses less memory than the conventional combination structure and enables faster computation by reducing the number of data accesses.

Accordingly, the present invention provides a new algorithm that adds a computation dimension (filter width dimension, Wf) that expresses the CNN filter spatial dimension, which could not be represented in conventional GEMM operations. In other words, by using the filter width dimension (Wf), the present invention addresses the inefficiency problems of conventional approaches that mapped CNN operations to GEMM computations.

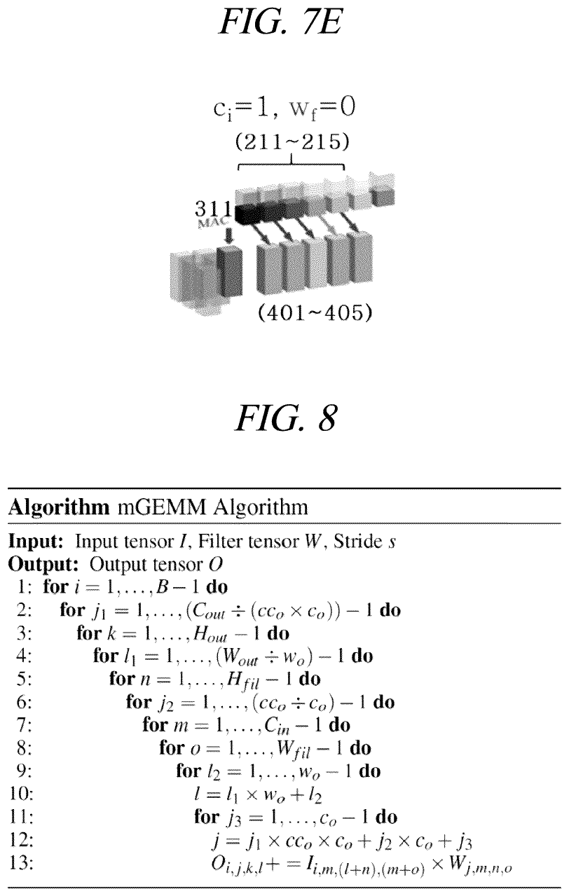

FIG. 8 illustrates an algorithm of a low-latency convolutional neural network operation method according to an embodiment of the present invention.

The present invention provides a method for improving conventional convolutional neural network (CNN) operations based on matrix multiplication (GEMM). By introducing a new computation dimension into the existing GEMM-based algorithm, a convolution operation optimized for mobile environments is proposed. For empirical validation, the algorithm was implemented on a processor based on the ARMv8 architecture, which is widely used in mobile systems, in the manner illustrated in FIG. 8. The inner kernel, which is the core component for implementing the convolution operation, is implemented using ARMv8-A assembly code as shown in FIG. 8. The code utilizes various hardware acceleration techniques such as ARM NEON and prefetching, and performs the computation in the most efficient manner according to fixed output width (wo) and output channel (co) values.

In the algorithm of FIG. 8, lines 7 to 13 constitute the inner kernel. The entire operation is implemented using a tiling method. Based on the input parameters of the workload, the inner kernel with the most efficient combination of wo and co values is selected and repeatedly executed to complete the entire operation.

For effective implementation, lines 1 to 6 split and reorder the input parameters appropriately so that maximum data reuse can be achieved within the hierarchical memory architecture of the given hardware. The Cout parameter is further divided into co and coo. Output tensor values are streamed at the register level, filter values are streamed from the L1 cache, and input values are streamed from the L2 or last-level cache, enabling sharing and reuse across various cores.

Additionally, based on the wo and co values, data access is arranged to occur sequentially. Input and output data are rearranged in the order of N-(C/co)-H-W-co, and filter data in the order of (K/co)-R-C-S-co.

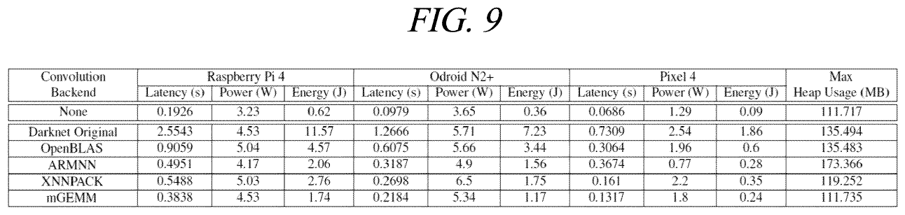

FIG. 9 illustrates a comparison of the low-latency convolution operation method according to an embodiment of the present invention with conventional methods.

Referring to FIG. 9, the computation code of mGEMM implemented according to the embodiment of the present invention was compared with conventional methods for the YoloV3-Tiny object detection task, and performance improvements were confirmed across various mobile devices.

That is, the mGEMM implemented as C-based software was tested in an ARMv8-based mobile environment, and the results showed a performance improvement ranging from 1.29× to 1.58× compared to existing methods.

An embodiment of the present invention may also be implemented as a computer-readable medium comprising instructions that are executable by a computer, such as a program module. The computer-readable medium may be any available medium that can be accessed by a computer, including both volatile and nonvolatile media, and removable and non-removable media. Additionally, the computer-readable medium may include computer storage media. The computer storage media include all media implemented in any method or technology for storing information such as computer-readable instructions, data structures, program modules, or other data, including volatile and nonvolatile media and removable and non-removable media.

Although the method and apparatus of the present invention have been described with reference to specific embodiments, components or operations thereof, all or parts thereof may be implemented using computer systems having a general-purpose hardware architecture.

The foregoing description of the present application is intended as illustrative and not limiting. Those skilled in the art to which the present invention pertains will appreciate that various modifications and alterations can be made without departing from the spirit and essential characteristics of the invention. Therefore, the embodiments described above are intended to be illustrative and not restrictive. For example, components described as being implemented as single units may be implemented in a distributed fashion, and vice versa.

The scope of the present invention is not defined by the foregoing detailed description but by the appended claims. All modifications and equivalent structures or methods deriving from the claims and their equivalents should be construed as being included within the scope of the present invention.

What is claimed is:

1. A low-latency convolution operation apparatus comprising:
a memory in which a matrix operation program is stored; and
a processor configured to execute the program stored in the memory,
wherein the matrix operation program includes:
a matrix operation unit configured to generate an output matrix through element-wise matrix operations between an input matrix and a filter matrix, wherein the matrix operation unit performs:
(a) matching rows of the input matrix with columns of the filter matrix in consideration of convolution parameters including stride and dilation;
(b) generating output blocks by computing input blocks that move in a horizontal direction and filter blocks that move in a depthwise direction along the width dimension of a filter tensor; and
(c) repeating steps (a) and (b), and aggregating all computed output blocks into a single matrix to generate the output matrix,
wherein the input matrix includes the input blocks in which a width dimension and a channel dimension are arranged in a horizontal direction and a vertical direction, respectively, and
the filter matrix includes the filter blocks in which the channel dimension is arranged in both the horizontal and vertical directions, and the width dimension is arranged in the depthwise direction.

2. The low-latency convolution operation apparatus according to claim 1,
wherein the matrix operation unit maps convolution computation dimensions for a target computation to GEMM computation dimensions and tiles the input matrix and the filter matrix into a plurality of blocks of a predetermined size.

3. The low-latency convolution operation apparatus of claim 1,
wherein the matrix operation unit is configured to calculate the output block based on the horizontal position of the input block and the depthwise position of the filter block according to the following Equation 1:
$$Wo + Wf - 1 \qquad < Equation 1 >$$
where Wo is the output width dimension and Wf is the filter width dimension.

4. A low-latency convolution operation method performed by a low-latency convolution operation apparatus,
comprising a step in which a matrix operation unit generates an output matrix through element-wise matrix operations between an input matrix and a filter matrix,
wherein the generation step includes:
(a) matching rows of the input matrix with columns of the filter matrix in consideration of convolution parameters including stride and dilation;
(b) generating output blocks by computing input blocks that move in a horizontal direction and filter blocks that move in a depthwise direction along the width dimension of a filter tensor; and
(c) repeating steps (a) and (b), and aggregating all computed output blocks into a single matrix to generate the output matrix,
wherein the input matrix includes the input blocks in which a width dimension and a channel dimension are arranged in a horizontal direction and a vertical direction, respectively, and
the filter matrix includes the filter blocks in which the channel dimension is arranged in both the horizontal and vertical directions, and the width dimension is arranged in the depthwise direction.

5. The low-latency convolution operation method of claim 4,
wherein before step (a), the matrix operation unit further performs mapping convolution computation dimensions for a target computation to GEMM computation dimensions, and tiling the input matrix and the filter matrix into a plurality of blocks of a predetermined size.

6. The low-latency convolution operation method of claim 4,
wherein the matrix operation unit is configured to calculate the output block based on the horizontal position of the input block and the depthwise position of the filter block according to the following Equation 1:
$$Wo + Wf - 1 \qquad < Equation 1 >$$
where Wo is the output width dimension, and Wf is the filter width dimension.
